(19) United States
(12) Patent Application Publication
(10) Pub. No.: US 2005/0203208 A1
(43) Pub. Date: Sep. 15, 2005

(54) Biologically and photochemically degradable polymeric compositions and film

(76) Inventor: Frank Anthony Ruiz, Flower Mound, TX (US)

Correspondence Address: JENKENS & GILCHRIST;A PROFESSIONAL CORPORATION, Lekha Gopalakrishnan, 1445 Ross Avenue, Suite 3200, Dallas, TX, 75202, US

(21) Appl. No.: 10/801,047

(22) Filed: Mar. 15, 2004

(51) Int. Cl. C08K 3/26; C08K 3/34

(52) U.S. Cl. 523/124; 524/425; 524/492

(57) ABSTRACT

The present invention is directed to mineral-filled polyester compounds and films which are produced by melt blowing polyester resins containing 10 to 50 wt % fillers. The fillers are selected from two different groups: the first consisting of block type fillers including inorganic carbonates, synthetic carbonates, feldspar, nepheline syenite, magnesium oxide, magnesium hydroxide, aluminum trihydrate, and diatomaceous earth; the second consisting of platy fillers including talc, mica, or calcined clays, all having a particle size less than 150 mesh. These fillers may be employed in mixtures to yield films and molded articles characterized by improved stiffness, handling, and end-use characteristics, increased rates of environmental degradation in biological and photochemical processes, and reduced cost.

### PRIOR RELATED APPLICATIONS

Not applicable.

### FEDERALLY SPONSORED RESEARCH STATEMENT

Not applicable.

### REFERENCE TO MICROFICHE APPENDIX

Not applicable.

### FIELD OF THE INVENTION

The invention is directed to polyester resins that comprise fillers such as an inorganic carbonate or a platy mineral such as talc, mica, or calcined clay, to produce polyester, melt blown film, cast film, or molded products. The invention further relates to a polyester resin composition which can provide a polyester film and molded polyester products that are biologically and photochemically degradable.

### BACKGROUND OF THE INVENTION

As a result of decreasing landfill space, and the increasing difficulty in finding and opening sites for new landfills, greater emphasis has been placed on the diversion of organic materials from disposal in landfills. A preferred method of diversion of organic waste from landfills is the practice of composting, whereby naturally-occurring organisms are used to break down the waste and allow it to be recycled back into the environment as an enhancement to soil or as a substrate for agriculture. Household lawn, leaf, garden, and yard waste, leftover food from households and commercial enterprises, and spoiled food culled from grocers, food distributors, and produce markets, all can and are being composted in large-scale commercial enterprises which continue to proliferate as a method of diverting valuable organics from landfills and allows them to be safely, economically, and beneficially recycled into the agricultural environment.

Over the last 40 years, trash bags and liners have become a preferred method of packaging waste for disposal due to their low cost, sanitary, cleanliness and odor-control benefits, and convenience for consumers, institutions, and industry. Unfortunately, the polyethylene polymers most widely used in these applications do not decompose in the composting environment and become a contaminant in the finished compost product, which must be removed prior to the composting process or screened out after to prevent a loss of compost value.

Additionally, other plastic articles, such as packaging film, plastic gloves used in preparing food, plastic bottles, plastic foodservice items such as plastic utensils and plates, and baby diaper backsheet will also act as contaminants if allowed to remain in the compost feedstock. It would be advantageous if these materials could be made biodegradable so they could decompose during the composting process, either through inadvertent addition to the organic waste stream, or as a method of disposal after their use. The ability of these types of articles to biodegrade will also allow them to biologically or photochemically decompose in the environment should they be discarded improperly as litter.

The major drawbacks to the widespread adoption of degradable and more specifically biodegradable and/or compostable polymers in commodity film application include high cost and the relative difficulty in processing and converting these polymers into films, coating, or molded articles when compared to the readily available polyolefin polymers currently utilized in these applications. In addition, biodegradable polymers have typically cost between 4 times to 10 times more than commodity polyolefins such as polyethylene or polypropylene.

A further barrier to the use of these materials has been the difficulty in converting these materials into films, coatings, or molded articles. Specifically, films produced from aliphatic-aromatic copolyesters display a very low stiffness. This makes them difficult to handle in conventional blown film processing equipment, as they are prone to unwanted stretching during winding, perforating, and other film processing.

The lack of stiffness of these materials also limits the ability of films manufactured from them to serve as load-bearing packages, such as bags, sacks, or liners. These films will stretch excessively in these applications, limiting their load bearing ability, and requiring an increase in film thickness, which further increases their cost.

Although degradable and more specifically biodegradable and/or compostable polyester resins have been developed, which will decompose under certain environmental conditions into water, carbon dioxide, and other naturally-occurring substances, these prior art resins do not possess the qualities of stiffness, processability and end-use performance that are desirable for most commodity film applications. Prior inventions have used a variety of methods to achieve the required strength and/or stiffness to allow satisfactory end-use performance of biodegradable polymers. GB 2,243,327 describes a method of combining a thin biodegradable thermoplastic polyester film into a sheet laminate with at least one layer of a fiber substrate comprised of biodegradable fibers. U.S. Pat. No. 4,880,592 described a method of preparing a biodegradable diaper backsheet by coextruding PHBV between two layers of sacrificial polymer, for example polyolefins, stretching and orienting the multilayer film, then stripping away the polyolefin layers after the PHBV film has had time to crystallize. Both of these methods add significant cost and complexity to the manufacture of the biodegradable film.

The present invention is directed to a combination of mineral additives which produce a film or molded article with improved stiffness, processability, and overall end-use performance, but do not interfere with the biodegradation of the plastic. The compounding of the mineral additives to the plastic resins permits the desired use, such as trash bag carry-out or other disposable bag, agricultural films, bottles, cups, pails, and other molded articles, and does not interfere with the biological actions that cause the plastic product to be environmentally biodegradable. The incorporation of mineral fillers also increases the rate of photo degradation when films and other articles are exposed to sunlight.

### SUMMARY OF THE INVENTION

An embodiment of the invention is directed to biologically degradable condensation polymer resins comprising about 10 wt % to about 60 wt % filler components. In certain embodiments of the invention, the resins comprise polyester or polyacid polymers. The polymer resins comprising filler components may be used to produce film, sacks, bags and liners.

In an embodiment of the invention, the filler component may be selected from one of two groups. The first group of filler components includes platy minerals including, but not limited to, talc, mica, and calcined clays. The second group of filler components includes, but is not limited to, inorganic carbonate, synthetic carbonates, nepheline syenite, magnesium hydroxide, aluminum trihydrate, diatomaceous earth, natural or synthetic silicas, and mixtures thereof, having a particle size of less than 150 mesh.

An embodiment of the invention provides biologically degradable condensation polymer resins, particularly resins containing polyester or polyacid polymers, whose processing and end-use performance are enhanced by the incorporation of the combination of one or more fillers.

An embodiment of the invention is directed to photodegradable polymer resins comprising polyester or polyacid polymers, which display enhanced degradability upon exposure to sunlight.

### DESCRIPTION OF EXEMPLARY EMBODIMENTS

The incorporation into condensation polymer resins, particularly resins containing polyester or polyacid polymers, of various mineral fillers such as platy minerals like talc, mica, and calcined clay, or inorganic carbonates, facilitates the reduction of the stiffness of polyester resin-based films, and enhances their usefulness in several applications. With the incorporation of the appropriate type and amount of fillers, the properties of films manufactured from aliphatic-aromatic copolyesters can be made comparable to those manufactured from commodity polyolefin polymers in terms of their handling, conversion and end-use characteristics.

The addition of fillers does not diminish the film's ability to biodegrade under the conditions for which they were originally developed. Indeed, films made from these compounds display an increased rate of degradation when compared to their unmodified counterparts, thereby imparting a significant advantage to the modified films. A further advantage of mineral incorporation into these aliphatic-aromatic polyesters is that the rate of degradation is increased when films or other articles manufactured from them are exposed to sunlight (photo-degradation).

An embodiment of the invention is directed to melt blowing aliphatic-aromatic copolyester resins which contain 10 to 60 wt % of one or more filler components. Heretofore, polyester resins have rarely been used in the melt blowing process, and when used did not contain over 5 wt % of any filler since it was believed that filler addition would cause weakening of the film or a loss of its biological degradability. In accordance with an embodiment of the invention, certain aliphatic-aromatic copolyester resins can be used to produce melt blown film comprising one or more filler components. The filler components used to fill a polyester resin may be selected from a first group of filler components including, but not limited to, platey minerals such as talc, mica, and calcined clays or mixtures thereof, having a particle size less than 150 mesh.

Alternately the filler components used may be selected from a second group of filler components including, but not limited to, inorganic carbonates, synthetic carbonates, nepheline syenite, magnesium hydroxide, aluminum trihydrate, diatomaceous earth, natural or synthetic silicas or mixtures thereof, having a particle size less than 150 mesh.

In an embodiment of the invention, the fillers incorporated in the resins are free of water. The surface of inorganic carbonate fillers may be treated so as to not adsorb water which could adversely affect the quality of the film produced by the melt blown process by causing steam and holes to appear. Accordingly, carbonate fillers, such as calcium carbonate, are treated with organic acids to assist the processability of the carbonate and to produce a more hydrophobic filler product. Acids such as stearic, palmitic, or behenic acid are conventional acids used for surface treatment the carbonates or other fillers. Non-carbonate fillers are often treated with silanes or other organic compounds to improve their compatibility with the polymer resin and to enhance physical properties of the film.

The filler components are incorporated in the polyester resins are levels of about 10 to about 60 wt %. In an embodiment of the invention, the filler components are present at levels of 20 to 50 wt %.

In certain embodiments of the invention, a first filler component is incorporated in a polyester resin at a level of about 5 to about 50 wt %. In other embodiments, a second filler component is present at a level of about 10 to about 60 wt %. In certain embodiments of the invention, the second filler component is present at a level of about 20 wt % to about 50 wt %.

The polyester resins that are melt blown into film products according to the invention include, but are not limited to, polyester resins sold under the trademarks Ecoflex®, Biopol™, NatureWorks™, and Biomax™. Ecoflex® is an aliphatic-aromatic copolyester based on terephthalic acid, adipic acid, 1,4-butanediol and modular units. Biopol™ is a polyhydroxylalkanoate (PHA) that is produced directly from renewable resources by microbial fermentation. NatureWorks™ is a plastic called polylactide (PLA) that is derived from plant starches and natural plant sugars. Biomax™ is a hydro/biodegradable resin.

The term “polyester or polyacid polymer resin” as used herein includes any resin where the monomer units (polybasic organic acids and/or polyhydric acids) are joined via an ester linkage. Examples of certain of the polyester resins used in embodiments of the invention are provided in the foregoing list.

In certain embodiments of the invention, the polyester resins are copolymers of an aromatic or aliphatic di-acid and an aromatic or aliphatic di-alcohol. The term “polyester copolymer resin” as used herein, refers to polyester or polyacid polymer resins comprising at least two monomers. Polyacid resins may contain a single type of monomer, for example poly-lactic acid, or may contain more than one type of monomer. The density of the polyester or polyacid polymer resins are between about 1.2 and about 1.3 g/cm³ and the molecular weights may range between about 100,000 and about 250,000. The melt flow index of the polyester or polyacid polymer resins may range from about 20 to about 1 gram/minute (ASTM D 1238). The broad range of melt flow indices is not intended to infer that the range is applicable to each specific resin, but rather that resins which display melt flow indices in the range of about 1 to about 20 g/minute are capable of being melt blown into film when mixed with filler components.

Melt blowing of polyester films which contain 5 wt % or more of a filler component has not been done heretofore. Surprisingly, these high loadings of fillers are without detriment to the film blowing capabilities of the polyester resins of the present invention. In fact, certain film properties are improved greatly by the incorporation of the proper mineral fillers. These properties include improved stiffness and tear strength. During the melt blowing process, the polyester is extruded through a circular die having a gas, usually air, blown into the circle of resin to form a bubble which is pulled upward until the resin cools and the resin film is then run through rollers which collapse the bubble and forms a continuous cylinder of film. The apparatus for melt blowing film comprises an extruder, a circular die, an air ring for blowing air into the die, a collapsible frame for collapsing the bubble formed, nip rolls and a winder for the collapsed film. The film is then slit to form a sheet which usually is twice the size of the collapsed film (a cylinder of film) or in other words is about the size of the circumference of the bubble formed.

A further embodiment of the invention is directed to compostable polyester melt blown film. According to an embodiment of the invention, melt blown polyester resins are combined with filler components in ratios that determine the final characteristics of the film or bag. In certain embodiments of the invention, filler components of one or more types are combined with polyester resins. Addition of filler components improves the stiffness of the film, its handling characteristics, and its usefulness as an end product. In an embodiment of the invention an end product manufactured from a polyester resin film comprising one or more filler components, is a bag used for packaging and handling compostable organic waste.

The term “degradable” as used herein means that during the degradation process, the polyester exhibits more than loss of physical properties such as brittleness or loss of tensile strength, but in addition displays loss of molecular weight. One of the degradation mechanisms of the polyester resins and films made from them may be characterized as photo-chemical because degradation on exposure to UV light (photodegradable) is accelerated. Alternatively, exposure to a bio initiator (biodegradable, as in a composting environment) causes degradation to be initiated and to take place through the biologically-catalyzed hydrolysis of the ester bonds which link together the monomer units forming the backbone of the polymer.

The rate of degradability of the condensation (polyester) film may be increased by increasing the amount of fillers. Another factor, is the environment of polyester film product which accelerates the degradation process. Therefore, if the product is used outdoors and subjected to sunlight (UV), the degradation of the film product is accelerated.

Another potential application for degradable films of the invention are agricultural films which conserve moisture and prevent weeds from growing and taking nutrients from the growing crop. These polyester film covers provide protection from pests, wind and moisture loss, and cut down or eliminate the need for chemical sprays. Since melt blown polyester films do not use a plasticizer or solvent, the film does not give off solvents or odors.

Another application for degradable polyester films are the conventional film markets; however, what is added to the conventional film is the low cost and degradability features of the present invention. Products such as films for packaging, wraps, containers and disposables, especially disposable diapers and bags can be made compostable and biodegradable at lower cost and better performance with the present invention. Most of the minerals in these formulations are safe for use in plastics in food-contact applications.

As discussed earlier, it is common practice for commercial calcium carbonates to be surface treated with 1 wt % of an organic acid such as stearic acid, palmitic acid, behenic acid, oleic acid, or with mixtures of two or more of these acids to aid in the processability of the carbonate. These levels generally are at or below 1.6% by weight of the mineral carbonate. Other minerals are often treated with various organic compounds, including organic acids, organo-functional silanes, or titanates to improve their compatibility with the polymer and improve physical properties.

The present invention will be explained more specifically with reference to the following examples, which are intended to be provide exemplary illustrations of the present invention. It will be apparent to those skilled in the art that various alterations, modifications, or improvements can be made to the examples without departing from the spirit of the present invention. Therefore, the scope of the present invention is in no way limited by these examples.

### EXAMPLE 1

60 wt % of a polyester polymer-Ecoflex F by the BASF Corporation; and 40 wt % calcium carbonate (CaCO₃) are mixed and added to a Brabender preparatory mixer. The resultant mixture is granulated to reduce its size, then processed on a ¾″ extruder into a film of about 2 mil thickness. This illustrates the film manufacture of a polyester resin with very high filling of inexpensive minerals. The properties of this film are summarized in Table 1. This example illustrates that very high loading of fillers in a polyester resin will produce a film with excellent strength.

### EXAMPLE 2

60 wt % polyester copolymer, BASF Ecoflex F, 20 wt % calcium carbonate (Imerys Supercoat), 20 wt. % talc (Specialty Mineral Clearbloc 80) are compounded on a Farrel Compact Processor Model 45, consisting of a continuous mixer and melt extruder, and then pelletized on a Gala underwater pelletizing system. The compound pellets were melt blown into a 1.25 mil film on a 60 mm Gloucester grooved feed extruder fitted with an 8 inch diameter annular die utilizing a 0.040 inch die opening (die gap). The film bubble produced was collapsed into a flattened tube, sealed and perforated into bags on a Gloucester Model 418 bag machine, then separated and stacked into individual bags for packing.

The addition of fillers which cost under $0.20/lb when added to resins which cost $1.80/lb. illustrates the great advantage of the present invention. The filled compound was melt blown readily into film and converted into bags on equipment which had been set up to extrude and convert bags from commodity linear-low density polyethylene and high-molecular weight high density polyethylene, the two most commonly used polymers in packaging and liner applications.

### EXAMPLES 3-10

The compositions of Examples 3 through 10 are summarized in Table 1. Each of these compounds was produced on a Brabender Preparatory Mixer, granulated, and extruded into a cast film on a Brabender ¾″ extruder fitted with a 4″ wide flat die. The mechanical properties of these films, are shown in Table 2. The stiffness of the films, as measured by 1% Secant Modulus (ASTM D 882), and tear strength, as measured by ASTM D 1922, are both improved with the addition of mineral filler.

TABLE 1
Biodegradable Mineral Filled Polyester Compound Compositions

| Exam- | | | | | |
|---|---|---|---|---|---|
| ple | % | | Talc | Calcium | Calcium |
| No. | Ecoflex F | Talc Type | % | carbonate type | Carbonate % |
| 3 | 100% | — | — | — | — |
| 4 | 60% | Clearbloc 80 | 40% | — | — |
| 5 | 65 | Clearbloc 80 | 35% | — | — |
| 6 | 70 | Clearbloc 80 | 30% | — | — |
| 7 | 60% | Clearbloc 80 | 30% | Supercoat | 10% |
| 8 | 70% | Clearbloc 80 | 20% | Supercoat | 10% |
| 9 | 50% | Clearbloc 80 | 30% | Supercoat | 20% |
| 10 | 60% | — | — | Supercoat | 40% |

TABLE 2
Degradable Film Mechanical Properties

| | 1% Secant | Elmendorf Tear | |
|---|---|---|---|
| | Modulus, | Strength, g/mil | Pendulum |
| Example | MD/TD | MD/TD | Impact, J/mm |
| No. | (ASTM D 882) | (ASTM D 1922) | (ASTM D 3420) |
| 3 | 11,127/12,961 | 419/953 | 0.54 |
| 4 | 31,920/25,204 | 455/878 | 0.52 |
| 5 | 32,337/25,232 | 461/525 | 0.58 |
| 6 | 26,573/21,342 | 347/1331 | 0.61 |
| 7 | 34,477/25,798 | 341/1276 | 0.40 |
| 8 | 34,474/26,200 | 308/1420 | 0.40 |
| 9 | 35,962/27,177 | 173/587 | 0.36 |
| 10 | 23,396/18,643 | 451/1282 | 0.44 |

The time frame at which degradation was observed in a biologically-active environment, as represented by a dramatic loss of film strength, or the level of deterioration which precluded their removal from the exposure environment without disintegration, is shown in Table 3. Films were exposed to a simulated composting environment under the conditions specified in ASTM Test Method D 5338: Test Method for Determining Aerobic Biodegradation of Plastic Materials Under Controlled Composting Conditions. Carbon dioxide was not collected to determine the level of mineralization; only the level of mechanical deterioration was determined.

TABLE 3
Degradable Film - Environmental Properties

| | Time to film biodegradation, |
|---|---|
| Example | days* |
| No. | (ASTM D 5338) |
| 3 | 120 |
| 4 | 90 |
| 5 | 90 |
| 6 | 90 |
| 7 | 90 |
| 8 | 90 |
| 9 | 90 |
| 10 | 120 |

Of great importance is that not only did the addition of mineral fillers increase the stiffness and tear strength of the film, and reduce the cost of the biodegradable polyester, the rate at which the films are biologically degrading has been increased with the addition of the fillers.

Another significant property of the invention is that the rate of photodegradation of the film or other finished article is greatly accelerated by the addition of the filler. This important as when the film is used in the composting process, such as a windrow cover, to produce bags which are used to package and transport organic waste to the composting facility, or other plastic articles which are designed to be composted. During the turning of the windrow or “pile” in the composting operation, plastic film or bags are often moved from the center of the composting mass to the outer surface where the biological activity is minimal and therefore biodegradation occurs at a much slower rate. The plastic will then be exposed to sunlight instead of composting microbes.

### EXAMPLES 11-14

The compositions of Examples 11 through 14 are summarized in Table 4. These compounds were prepared using a Brabender Preparatory Mixer, granulated, and extruded into a cast film on a Brabender ¾″ extruder fitted with a 4″ wide flat die.

TABLE 4
Photodegradable Mineral-Filled Polyester Compound Compositions

| Example No. | % Ecoflex F | Talc Type | Talc % |
|---|---|---|---|
| 11 | 100% | — | — |
| 12 | 90% | Microtuff F | 10% |
| 13 | 70 | Microtuff F | 30% |
| 14 | 50 | Microtuff F | 50% |

Films prepared from these formulations were exposed to ultraviolet light in a QUV apparatus according to ASTM Standard Practice G53, using a cycle of 20 hours UV light/4 hours condensation. The effect of mineral addition to the aromatic-aliphatic copolyester on the photodegradation rate of films produced from these formulations is shown in Table 5. Exposure time is in hours of time in the light. The level of photodegradation is determined by the tensile elongation of films as measured using ASTM D 882. For any elongation value less than 5%, the film is considered to be photodegraded.

TABLE 5
Photodegradation Rate of Mineral-Filled Polyester Compound Based Films

| | 0 hours | 80 hours | 160 hours | 240 hours | 320 hours |
|---|---|---|---|---|---|
| Example No. | exposure | exposure | exposure | exposure | exposure |
| 11 | 194% | 83% | 34% | 31% | 29% |
| 12 | 296% | 29% | 27% | 27% | 19% |
| 13 | 244% | 18% | 13% | 7% | 4% |
| 14 | 182% | 8% | 5% | 3% | 2% |

It is apparent from the results in Table 5 that the rate of photodegradation is greatly accelerated with the addition of mineral filler to the aliphatic-aromatic copolyester. This means that plastic exposed to the sunlight at the surface of a compost pile or windrow instead of in its center will continue to degrade at an accelerated rate. The property will also be useful in aiding the degradation of plastic which is littered into the environment, as litter is often exposed to sunlight after being discarded improperly.

1. A resin composition comprising,
(a) 50 to 90 wt % of a polyester resin, and
(b) a filler component having a particle size of less than 150 mesh,
wherein said composition is degradable.

2. The resin composition of claim 1, wherein the polyester resin is an aliphatic-aromatic copolyester resin.

3. The resin composition of claim 1, wherein the polyester resin is a copolymer of an aromatic di-acid and an aliphatic di-alcohol.

4. The resin composition of claim 1, wherein the polyester resin is a copolymer of an aliphatic di-acid and an aromatic di-alcohol.

5. The resin composition of claim 1, wherein the filler component is selected from the group consisting of inorganic carbonate, synthetic carbonate, nepheline syenite, magnesium hydroxide, aluminum trihydrate, diatomaceous earth, natural silica, synthetic silica and mixtures thereof.

6. The resin composition of claim 1, wherein the filler component is selected from the group consisting of talc, mica, calcined clay and mixtures thereof.

7. The composition of claim 5, wherein the filler component is present at a range of about 5 to about 50 wt %.

8. The composition of claim 6, wherein the filler component is present at a range of about 10 to about 60 wt %.

9. The composition of claim 1, wherein said composition is biodegradable.

10. The composition of claim 1, wherein said composition is photochemically degradable.

11. A resin composition comprising
(a) 50 to 90 wt % of a polyester resin,
(b) a first filler component having a particle size of less than 150 mesh, and
(c) a second filler component having a particle size of less than 150 mesh,
wherein said composition is degradable.

12. The resin composition of claim 11, wherein the first filler component is selected from the group consisting of talc, mica, calcined clays and mixtures thereof.

13. The resin composition of claim 11, wherein the second filler component is selected from the group consisting of inorganic carbonate, synthetic carbonate, nepheline syenite, magnesium hydroxide, aluminum trihydrate, diatomaceous earth, natural silica, synthetic silica and mixtures thereof.

14. The resin composition of claim 11, wherein the first filler component is present at a range of about 5 to about 50 wt %.

15. The resin composition of claim 11, wherein the second filler component is present at a range of about 10 to about 60 wt %.

16. The resin composition of claim 11, wherein said composition is biodegradable.

17. The resin composition of claim 11, wherein said composition is photochemically degradable.

18. A film composed of a polyester copolymer resin comprising,
(a) 50 to 90 wt % of a polyester resin, and
(b) a filler component having a particle size of less than 150 mesh,
wherein said film is degradable.

19. The film of claim 18, wherein the filler component is selected from the group consisting of inorganic carbonate, synthetic carbonate, nepheline syenite, magnesium hydroxide, aluminum trihydrate, diatomaceous earth, natural silica, synthetic silica and mixtures thereof.

20. The film of claim 18, wherein the filler component is selected from the group consisting of talc, mica, calcined clay and mixtures thereof.

21. The film of claim 19, wherein the filler component is present at a range of about 5 to about 50 wt %.

22. The film of claim 20, wherein the filler component is present at a range of about 10 to about 60 wt %.

23. The film of claim 18, wherein said film is biodegradable.

24. The film of claim 18, wherein said film is photochemically degradable.

25. A film composed of a polyester copolymer resin comprising,
(a) 50 to 90 wt % of a polyester resin,
(b) a first filler component having a particle size of less than 150 mesh, and
(c) a second filler component having a particle size of less than 150 mesh,
wherein said film is degradable.

26. The film of claim 25, wherein the first filler component is selected from the group consisting of talc, mica, calcined clays and mixtures thereof.

27. The film of claim 25, wherein the second filler component is selected from the group consisting of inorganic carbonate, synthetic carbonate, nepheline syenite, magnesium hydroxide, aluminum trihydrate, diatomaceous earth, natural silica, synthetic silica and mixtures thereof.

28. The film of claim 26, wherein the first filler component is present at a range of about 5 to about 50 wt %.

29. The film of claim 27, wherein the second filler component is present at a range of about 10 to about 60 wt %.

30. The film of claim 25, wherein said film is biodegradable.

31. The film of claim 25, wherein said film is photochemically degradable.

32. A product composed of a polyester film, wherein said film comprises
(a) 50 to 90 wt % of a polyester resin, and
(b) a filler component having a particle size of less than 150 mesh.,
wherein said film is degradable.

33. The product of claim 32, wherein the filler component is selected from the group consisting of inorganic carbonate, synthetic carbonate, nepheline syenite, magnesium hydroxide, aluminum trihydrate, diatomaceous earth, natural silica, synthetic silica and mixtures thereof.

34. The product of claim 32, wherein the filler component is selected from the group consisting of talc, mica, calcined clay and mixtures thereof.

35. The product of claim 33, wherein the filler component is present at a range of about 5 to about 50 wt %.

36. The product of claim 34, wherein the filler component is present at a range of about 10 to about 60 wt %.

37. The product of claim 32, wherein said product is biodegradable.

38. The product of claim 32, wherein said product is photochemically degradable.

39. A product composed of a polyester film, wherein said film comprises
(a) 50 to 90 wt % of a polyester resin,
(b) a first filler component having a particle size of less than 150 mesh, and
(c) a second filler component having a particle size of less than 150 mesh,
wherein said film is degradable.

40. The product of claim 39, wherein the first filler component is selected from the group consisting of talc, mica, calcined clays and mixtures thereof.

41. The product of claim 39, wherein the second filler component is selected from the group consisting of inorganic carbonate, synthetic carbonate, nepheline syenite, magnesium hydroxide, aluminum trihydrate, diatomaceous earth, natural silica, synthetic silica and mixtures thereof.

42. The product of claim 40, wherein the first filler component is present at a range of about 5 to about 50 wt %.

43. The product of claim 41, wherein the second filler component is present at a range of about 10 to about 60 wt %.

44. The product of claim 39, wherein said product is biodegradable.

45. The product of claim 39, wherein said product is photochemically degradable.
